(19) United States
(12) Patent Application Publication
(10) Pub. No.: US 2005/0052057 A1
(43) Pub. Date: Mar. 10, 2005

(54) Fluid collection method and apparatus particulary suited to crushed vehicle hauling

(76) Inventor: Scott Siebel, Taylor, MI (US)

Correspondence Address: John G. Posa;Gifford, Krass, Groh, Sprinkle,, Anderson & Citkowski, P.C., 280 N. Old Woodward Ave., Suite 400, Birmingham, MI, 48009-5394, US

(21) Appl. No.: 10/875,887

(22) Filed: Jun. 24, 2004

Related U.S. Application Data
(60) Provisional application No. 60/483,979, filed on Jul. 1, 2003.

(51) Int. Cl. B62D 33/023

(52) U.S. Cl. 296/208

(57) ABSTRACT

Fluid collection for trailers of the type used to haul scrap such as crushed/flattened vehicles comprises a floor having an upper surface with a peripheral edge; a hollow, tubular member adjoining at least a portion of the peripheral edge, at least a portion of the hollow, tubular member extending above the upper surface of the floor; and wherein the hollow, tubular member further includes one or more perforations aligned with the upper surface of the floor such that oil, gas, or other fluids on the floor flow into the hollow, tubular member through the perforations. The trailer may additionally include apparatus for recovering oil, gas, or other fluids collected in the hollow, tubular member. Such an apparatus may include, by way of example, one or more bottom-oriented drain plugs. In addition, the apparatus may include a source or air or inert gas for blowing into one end of the hollow, tubular member while collecting the oil, gas, or other fluids at the other end of the hollow, tubular member.

### REFERENCE TO RELATED APPLICATION

This application claims priority from U.S. Provisional Patent Application Ser. No. 60/483,979, filed Jul. 1, 2003, the entire content of which is incorporated herein by reference.

### FIELD OF THE INVENTION

This invention relates generally to waste and scrap hauling and, in particular, to fluid collection for trailers of the type used to haul scrap such as crushed/flattened vehicles.

### BACKGROUND OF THE INVENTION

The recycling of wrecked cars now represents a substantial business. Such vehicles are first stripped of non-metal parts and hazardous materials, then crushed or flattened to consume less space during transport to a recycling station where they are chipped into small pieces. The small pieces are then sold to be melted down.

Standard flatbed trailers are commonly used to transport the crushed or flattened vehicles. The flattened vehicles are typically loaded on the flatbed in stacks using a fork-lift, and each stack is secured with tie-down chains.

There are disadvantages associated with the use of flatbed trailers, however. For one, when the wrecked vehicles are crushed or flattened, stress is put on various parts such as mirrors and moldings that may become dislodged or loose in transit, resulting in dangerous debris on the highway. Another disadvantage is that if the load has shifted, adjustments should be made to the tie-downs, which are difficult to inspect and secure. Manipulating the chains across the stacks can be unsafe, as the stacks of vehicles are unstable and are prone to slip or tip over.

Various alternative trailers are used to overcome these disadvantages. A common approach is the use of a three-sided trailer of the type disclosed, for example, in U.S. Pat. No. 5,599,058. A twelve-foot high retainer wall of solid sheet steel is also provided on the three walled sides around the bottom periphery to prevent any small pieces of debris from falling off the trailer bed on those sides. The open side of the trailer is located on the side of the transport vehicle that will be toward the berm of the road, so that any debris failing in that direction will fall to the side of the road.

In accordance with U.S. Pat. No. 5,876,164, there is provided a device for carrying car frames or the like, comprising a rectangular base member comprising at least one trailer bed, and means for mounting said base member on wheels. Transverse members are spacedly mounted on the base member and a first vertical protection wall is mounted at a front end of the base member. A second vertical protection wall is mounted on one longitudinal side of the base member, the other longitudinal side being free of vertical protection wall, and a third vertical protection wall is mounted at a rear end of the base member. Support means extend vertically from the transverse member and are aligned along a straight line spaced at an equal distance from the second protection wall. A non-slip member is disposed along the other longitudinal side of the base member, and means for securing a load of car frames are stacked on the transverse members between the support means and the non-slip members.

In accordance with a preferred embodiment, the base member comprises a front trailer bed and a rear trailer bed, the rear trailer bed being articulated to the front trailer bed, the first vertical protection wall being mounted at the front of the front trailer bed, the third vertical protection wall being mounted at the rear of the rear trailer bed, the second vertical protection wall being mounted on the longitudinal left sides of both front and rear trailer beds.

In addition to problems associated with the loss of vehicle parts from such trailers, other undesirable situations may arise due to the loss of oil, gas, hydraulic fluids and other liquids during hauling. Thus, despite advances of the type described above, the need remains for a trailer with a capability for collecting such fluids.

### SUMMARY OF THE INVENTION

This invention relates generally to waste and scrap hauling and, in particular, to fluid collection for trailers of the type used to haul scrap such as crushed/flattened vehicles. In conjunction with a trailer having a set of wheels, a preferred embodiment comprises a floor having an upper surface with a peripheral edge; a hollow, tubular member adjoining at least a portion of the peripheral edge, at least a portion of the hollow, tubular member extending above the upper surface of the floor; and wherein the hollow, tubular member further includes one or more perforations aligned with the upper surface of the floor such that oil, gas, or other fluids on the floor flow into the hollow, tubular member through the perforations.

The trailer may additionally include apparatus for recovering oil, gas, or other fluids collected in the hollow, tubular member. Such an apparatus may include, by way of example, one or more bottom-oriented drain plugs. In addition, the apparatus may include a source or air or inert gas for blowing into one end of the hollow, tubular member while collecting the oil, gas, or other fluids at the other end of the hollow, tubular member.

### BRIEF DESCRIPTION OF THE DRAWINGS

FIG. 1 is a drawing which shows a preferred embodiment of the invention in use with respect to a flat-bed trailer; and

FIG. 2 shows an alternative embodiment of the invention adapted for use with a step-down floor configuration.

### DETAILED DESCRIPTION OF THE INVENTION

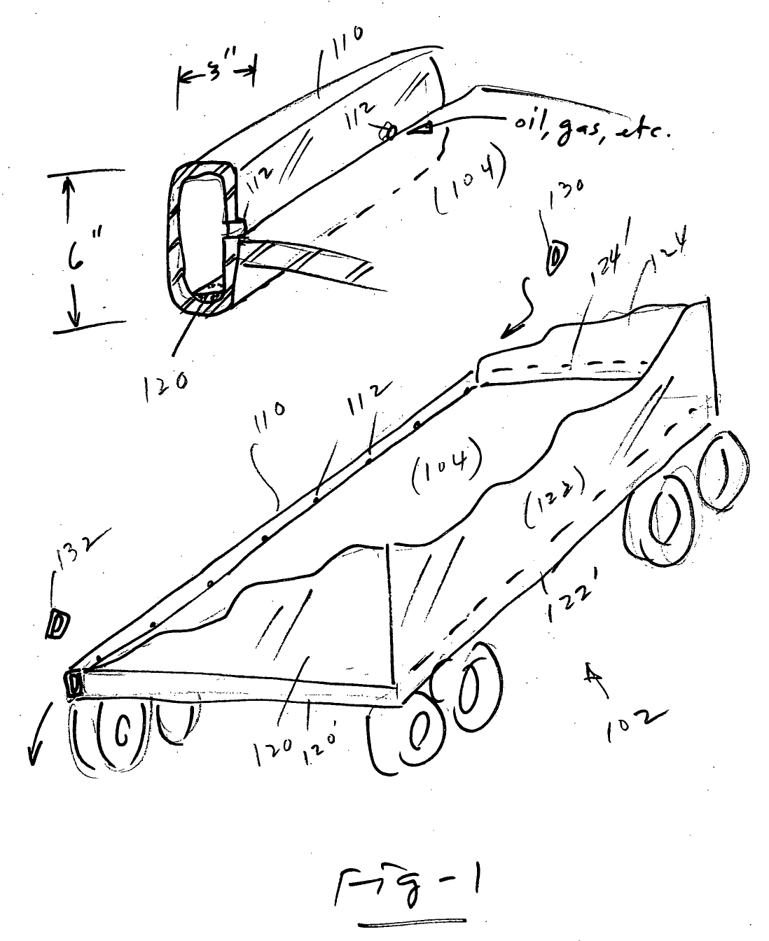

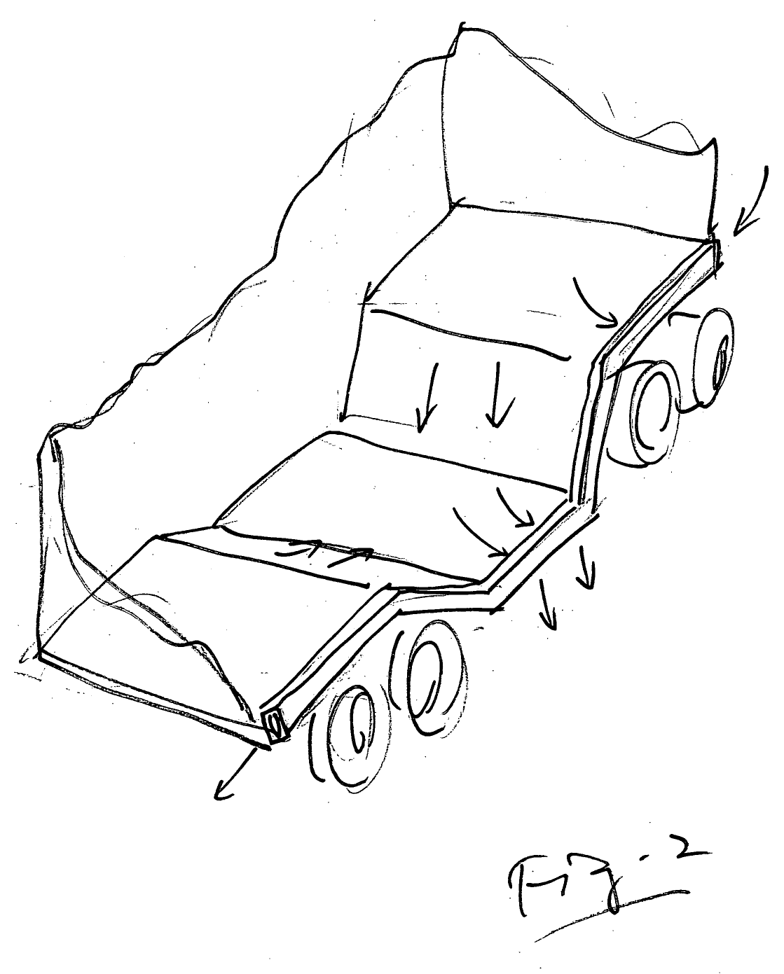

Reference is made to the drawings, and to FIG. 1 in particular, which shows a preferred embodiment of the invention in use with respect to a flat-bed trailer 102 having a floor 104. As shown in FIG. 2, however, the invention is not limited to flat-floored trailers, but may be used with any floor configuration.

Adjoined to at least a portion of the edge of the floor 104 is a hollow tubular member 110 having one or preferably a plurality of apertures 112. In the preferred embodiment, the hollow tubular member 110 is rectangular in cross-section, measuring three inches by six inches, or thereabouts, and is welded to the edge of the floor 104 such that a portion of the member extends thereabove. The apertures 112 are formed through the wall of the member 110 to be very close in proximity to the upper surface of the floor 104, such that oil, gas, and other fluids falling onto the floor 104 fall into the apertures 112 and are collected as 120 in the hollow tubular member.

Although the hollow tubular member is shown adjoining only one edge of the floor 104, it may go further around the entire periphery of the floor as 120′, 122′, 124′. Or, alternatively, if walls 120, 122 or 124 are used extending above the floor 104, only one edge of the floor 104 may need to be equipped with the member 110 for fluid collection.

In terms of reclaiming fluids that have been collected into the member 110, different approaches may be used according to the invention. In the preferred embodiment, plugs 130 and 132 may be placed on the ends of the member 110 to cap it off, which may then be removed, allowing the fluid contained therein to either drain out or, pressure may be applied to one end while collecting at the other. Alternatively, one or more removable plugs may be placed at the bottom of the member 110 and simply removed, allowing gas, or other fluid to drain therefrom.

As shown in FIG. 2, the invention is not limited to trailers having flat floors, but may use step-down configurations, in which the hollow tubular members may either be independent, or joined, as shown.

1. A trailer with a set of wheels for hauling scrap in the form of crushed vehicles, and the like, the trailer comprising:
a floor having an upper surface with a peripheral edge;
a hollow, tubular member adjoining at least a portion of the peripheral edge, at least a portion of the hollow, tubular member extending above the upper surface of the floor; and
the hollow, tubular member further including one or more perforations aligned with the upper surface of the floor such that oil, gas, or other fluids on the floor flow into the hollow, tubular member through the perforations.

2. The trailer of claim 1, further including apparatus for recovering oil, gas, or other fluids collected in the hollow, tubular member.

3. The trailer of claim 2, wherein the apparatus includes one or more bottom-oriented drain plugs.

4. The trailer of claim 2, wherein the apparatus includes blowing into one end of the hollow, tubular member while collecting the oil, gas, or other fluids at the other end of the hollow, tubular member.
